(19) United States
(12) Patent Application Publication
(10) Pub. No.: US 2014/0077415 A1
(43) Pub. Date: Mar. 20, 2014

(54) TWISTING APPARATUS

(71) Applicant: RISCO S.P.A., Thiene (VI) (IT)

(72) Inventors: Giampietro RIGHELE, THIENE (VI) (IT); Filippo TONIELLO, THIENE (VI) (IT)

(73) Assignee: RISCO S.P.A., Thiene (VI) (IT)

(21) Appl. No.: 14/018,290

(22) Filed: Sep. 4, 2013

(30) Foreign Application Priority Data
Sep. 14, 2012 (IT) VR2012A000187

(51) Int. Cl. A23P 1/12

(52) U.S. Cl. CPC A23P 1/12
USPC 264/310

(57) ABSTRACT

A twisting apparatus is described. The twisting apparatus has a loading device adapted to load a food product inside a casing and a braking device. A filling assembly is adapted to support the casing. An inlet conduit is provided for feeding the food product into the filling assembly. The inlet conduit is structurally separate from the passage duct of the filling assembly and configured to assume at least one first operative position in which the filling assembly is connected to the braking device and the inlet conduit is in fluid communication with said passage duct and a second operative position in which the filling assembly is displaced in a spaced relationship or detached from the braking device.

### CROSS REFERENCE TO RELATED APPLICATIONS

The present application claims priority to Italian patent application VR2012A000187 filed on Sep. 14, 2012, incorporated herein by reference in its entirety. The present application is related to the Italian patent application VR2012A000186 filed on Sep. 14, 2012 incorporated herein by reference in its entirety. The present application is also related to U.S. patent application Ser. No. ______ for “Twisting apparatus” filed on even date herewith, Attorney Docket Number P1283-US, also incorporated herein by reference in its entirety.

### TECHNICAL FIELD

The present disclosure relates to a sector of twisting machines or apparatus intended, for example, to twist food products with a paste-like consistency such as minced meat, an emulsified product, a cold cut product or the like. Furthermore, the present disclosure relates to a twisting apparatus of the type including a filling cone or pipe which is mounted on a twisting apparatus.

### BACKGROUND

In twisting machines, the filling cone has a free end on which a casing is positioned, so that the food product may be filled inside the casing. After positioning of the casing, the free end of the filling cone is configured to be connected to a braking device which holds the casing and keeps it in a tensioned condition for allowing loading or filling of the food product in order to form an encased product. At regular intervals, a twisting device causes rotation of the filling cone so as to perform a twisting of the casing (held fast by the braking device) and division of the encased food product into segments or parts.

The present disclosure is based on the observation by the inventor of the present patent application that, in order to load the casing onto the free end of the filling cone, two different twisting systems have been proposed hitherto.

In a first twisting system, the filling cone has a telescopic structure. This filling cone, or filling assembly, is formed by several tubular bodies and is shortened with a variation in the internal volume. Owing to shortening, it is possible to space the free end of the filling cone from the braking device and allow mounting of the casing on the free end of the filling cone. Such a system has been recognized as being inconvenient since, owing to the variation of the internal volume, significant and undesirable leakage of food product from the filling cone occurs.

A second twisting system, which is able to overcome the above drawback, includes an apparatus in which the filling cone is stationary and the braking device is mounted movably, namely displaceable with respect to the filling cone, in order to be able to access the free end of the filling cone during loading of the casing so as not to require a displacement of the filling cone.

This second twisting system, however, involves constructional complications in order to ensure the mobility of any other processing apparatus associated with the braking device, such as belt or chain systems for conveying the product output downstream of the braking system.

### SUMMARY

According to some aspects of the present disclosure, the twisting apparatus comprises an inlet conduit and a filling assembly having a passage duct, wherein the inlet conduit is intended to introduce the food product into the filling assembly. The inlet conduit is structurally separate from the passage duct. Moreover, the filling assembly is configured to assume at least a first operative position, in which the filling assembly is connected to the braking device and said inlet conduit is in fluid communication with said passage duct, and a second operative position, in which the filling assembly is linearly displaced in a spaced relationship or detached from the braking device. In the second operative position, the passage duct closes or interrupts the fluid communication with the inlet conduit.

In other words, in the twisting apparatus according to some embodiments of the present disclosure, the food product is adapted to be loaded in a first part of the apparatus which can coincide with the inlet conduit, and in a second part of the apparatus which can coincide with the filling assembly. The first part and the second part are structurally independent from each other and can be moved one with respect to the other. When it is required to load the casing on the loading assembly, only the loading assembly, or second part of the apparatus, may be displaced with respect to the inlet conduit, or first part of the apparatus, and communication interrupted with the inlet conduit, without causing variations in the internal volume of the apparatus (e.g. inside the filling assembly and/or inside the inlet conduit).

Owing to the fact that the inlet conduit is structurally separate from the filling assembly, it is possible to displace only the filling assembly with respect to the inlet conduit so as to cause a relatively limited overall displacement of the filling assembly alone and limit overall the dimensions of the twisting apparatus. For example, according to some embodiments of the present disclosure, in order to optimize further the volumes and the overall dimensions of the twisting apparatus, the inlet conduit can be located on one side, for example underneath the filling assembly.

In certain embodiments of the present disclosure, the passage duct has a side wall and the inlet conduit is facing the side wall. In the first operative position, the inlet conduit is in fluid communication with an opening of the side wall and in the second operative position the side wall closes or interrupts the fluid communication with the inlet conduit. In other words, the side wall of the loading assembly serves as a shutter or for preventing the passage of food product and makes it possible to avoid leakage of food product from the twisting apparatus during loading of the casing. The passage duct can have the dual function of a conduit for loading the food product and a shutter for the inlet conduit. Owing to closing of the inlet conduit, it is possible to prevent the food product from being exposed to air during loading of the casing.

Further advantages, characteristic features and the modes of use of the subject of the present disclosure will become clear from the following detailed description of a number of preferred embodiments thereof, provided solely by way of non-limiting examples. It is clear, however, that each embodiment may have one or more of the advantages listed above; in any case it is not, however, required that each embodiment should have simultaneously all the advantages listed.

### BRIEF DESCRIPTION OF DRAWINGS

Reference shall be made to the figures in the accompanying drawings in which:

FIG. 1 shows a view from above of a twisting apparatus according to an embodiment of the present disclosure;

FIGS. 2-4 show views from above of a twisting apparatus according to an embodiment of the present disclosure in respective operative positions;

FIG. 5 shows an axonometric view of a twisting apparatus according to an embodiment of the present disclosure in a first operative position;

FIG. 6 shows an axonometric view of a twisting apparatus according to an embodiment of the present disclosure in a second operative position;

FIG. 7 shows a cross-sectional view along the line VII-VII of FIG. 2;

FIG. 8 shows a cross-sectional view along the line VIII-VIII of FIG. 3.

### DETAILED DESCRIPTION

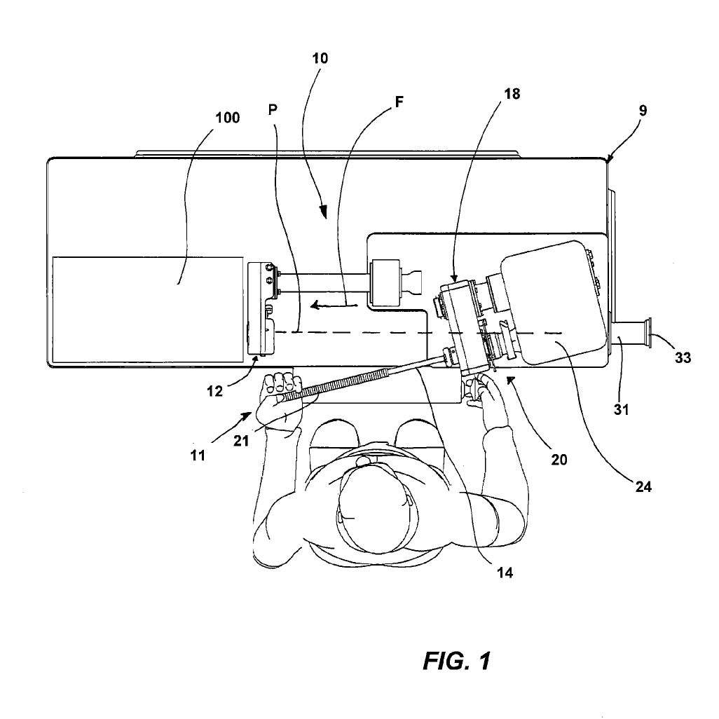

With reference to the accompanying figures, the reference number 10 denotes a twisting apparatus according to some embodiments of the present disclosure. The twisting apparatus 10 can comprise a frame 9, or support structure, and a loading device 20 for a food product, mounted on the frame 9. The food product is not shown in the drawings and may be, for example, a product based on minced meat or otherwise, or a product in the form of a paste, intended to be loaded or filled inside a casing 21. The casing 21 is schematically shown in FIG. 1 in a curled-up condition.

The twisting apparatus 10 may be associated, on one side, with a filling machine which feeds the product towards the twisting apparatus 10. On another side, the twisting apparatus 10 may be associated with a processing apparatus 100, where the food product is filled inside a casing 21 so as to form an “encased” food product. The processing apparatus 100 may have any form and function and does not form part of the present disclosure.

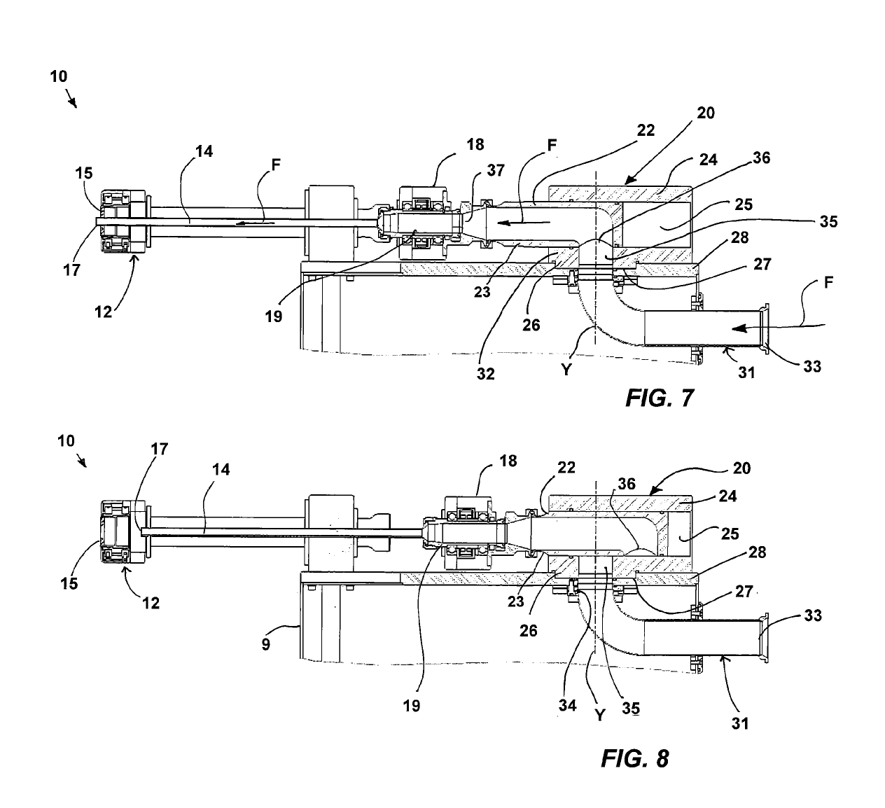

The food product, which is supplied from the filling machine and reaches the processing apparatus 100 passing through the twisting apparatus 10, defines a loading path P for the food product, which is in the direction of advancing movement of the food product. The direction of advancing movement is indicated by the arrow F in FIG. 1 (as well as in FIG. 7 described below). In connection with the present disclosure, each spatial reference, such as “alongside”, “on one side”, “upstream”, “downstream”, “horizontal” or “vertical”, “above” or “below”, “bottom”, “retracted” or “advanced”, or similar spatial references, are to be understood as referring by way of example to the twisting apparatus as arranged in FIGS. 1 and 7, when in operation, where the loading path P and the direction of advancing movement of the food product may be identified.

The loading device 20 can include a filling assembly 11 adapted to support the casing 21 and an inlet conduit 31 for feeding the food product into the filling assembly 11. The filling assembly 11 can include a filling cone 14 on which the casing 21 can be placed in the curled-up condition and a passage duct 22 arranged between the filling assembly 14 and the inlet conduit 31.

The filling cone or pipe 14 can be a pipe extending along a longitudinal axis X which, during operation, is coaxial with at least a portion of the loading path P for filling the food product inside the casing 21. In a normal and conventional operative condition, the longitudinal axis X is a horizontal axis. The passage duct 22 is, as mentioned above, situated upstream of the filling cone 14 and can place the inlet conduit 31 in fluid communication with the filling cone 14.

It can also be seen that, in an embodiment of the present disclosure, such as shown in the figures, the filling cone 14 can be mounted on a twisting device 18, which allows the filling cone 14 to rotate about its longitudinal axis X so as to perform twisting of the casing 21 when the casing 21 is mounted on a free end 13 of the filling cone 14.

The twisting device 18 is of the type known in the sector and comprises a rotating actuating member connected by means of a belt or similar movement transmission device for transmitting a transmission movement to the filling cone 14. The filling cone 14 is fixed to a tubular body 19 of the twisting device 18, which is connected to the actuating member. The food product is adapted to pass inside the tubular body 19.

The twisting apparatus 10 can also comprise a braking device 12, of the type known to a person skilled in the art, which is connected to the loading device 20 by means of a rigid arm 16. The braking device 12 can be provided with a bush 15, called a brake, configured to hold fast the casing 21 and produce a tension necessary for optimum filling of the product inside the said casing 21. The braking device 12 is provided with an opening 13 for receiving the free end portion 17 of the filling cone 14. The connection between the loading device 20 and the braking device 12, via the arm 16, is also of the type known to a person skilled in the art.

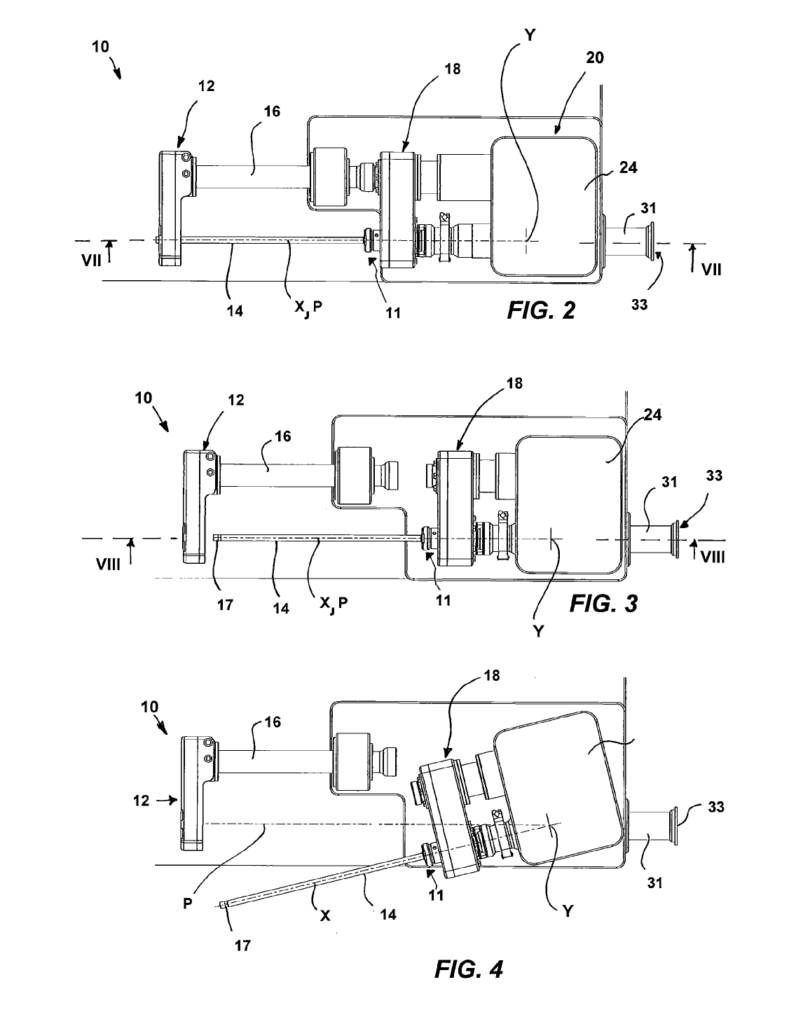

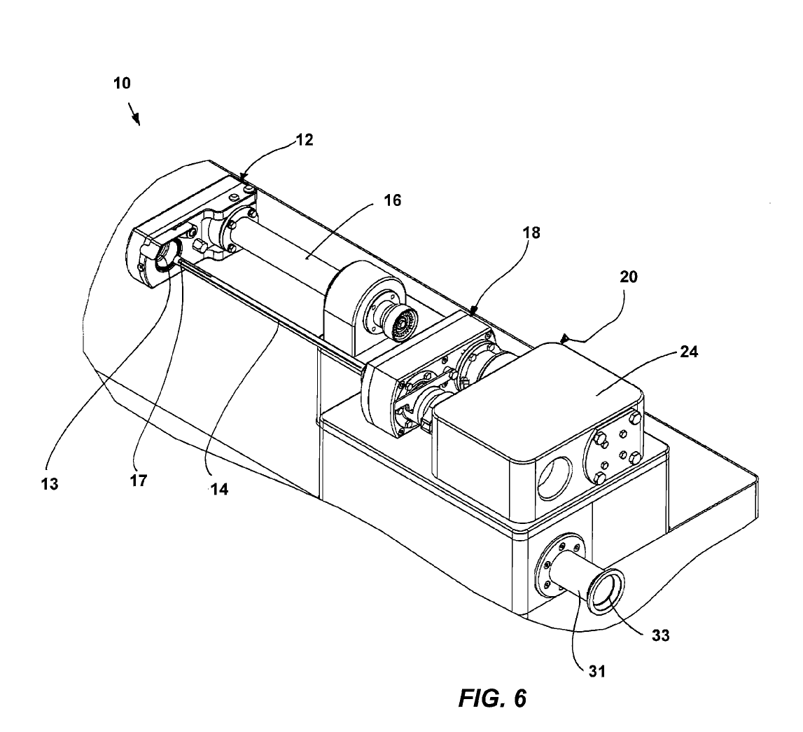

According to an aspect of the present disclosure, the filling assembly 11 may assume at least two, and optionally three, operative positions different from each other. By way of example, a first loading operative position is visible in FIG. 2, FIG. 5 and FIG. 7 and corresponds to a position in which the food product is loaded into the casing 21. In this first operative position, the filling cone 14 is arranged along the loading path P and has a respective free end portion 17, which is housed inside the opening 13 of the braking device 12.

A second operative position is visible, by way of example, in FIG. 3, FIG. 6 and FIG. 8 and corresponds to a position in which the aforementioned free end portion 17 of the filling cone 14 is spaced from the braking device 12. In this second operative condition, the casing 21 may be mounted on the filling cone 14, without interfering with the braking device 12. In this second operative position, the filling cone 14 has its respective free end portion 17 spaced from the opening 13 of the braking device 12. More particularly, in this second operative position, the filling cone 14 is axially aligned with the opening 13 of the braking device 12 in a position which is linearly retracted with respect to the first operative position, towards an upstream zone of the braking device 12.

In particular, it can be seen that the entire filling assembly 11 is displaced from the first operative position to the second operative position and vice versa. In accordance with certain aspects of the present disclosure, with reference to FIGS. 7 and 8, the inlet conduit 31 is structurally separate from said passage duct 22 and is situated on one side of said passage duct 22 so that, when the filling assembly 11 is in the first operative position, the inlet conduit 31 is in fluid communication with said passage duct 22 and, when the filling assembly 11 is in the second operative position, the passage duct 22 closes or interrupts the fluid communication with the inlet conduit 31 so as to act as a fluid communication interrupter.

In accordance with an embodiment such as that visible in the figures, the passage duct 22 has a side wall 23 and the inlet conduit is facing said side wall 23. In the first operative position, the inlet conduit 31 is in fluid communication with an opening of the side wall 23 and in said second operative position the side wall 23 closes or interrupts the fluid communication with the inlet conduit 31. For example, when the filling assembly 11 is in the first operative position, an inlet mouth 36 of the passage duct 22 is axial alignment with an output mouth 34 of the inlet conduit 21.

According to an embodiment of the present disclosure, such as shown in the accompanying figures, the loading device 20 can comprise, in addition to the twisting device 18 and the passage duct 22, a case-shaped support structure 24 which is configured to support the passage duct 22.

The support structure 24 can comprise an internal cavity 25, which is configured to receive the passage duct 22 when the filling assembly 11 is in the second operative position. In particular, the passage duct 22, in the second operative position, occupies a free zone (cavity 25) inside the support structure 24 so as not to occupy additional spaces and allow the maximum dimensions of the entire twisting apparatus 10 to be limited.

Moreover, the cavity 25 is intended to receive any remains of food product leakage from the ducts so as to reduce to a minimum the risk of soiling a zone around the twisting apparatus 10. Furthermore, it is possible to prevent the food product from being exposed to air.

According to further aspects of the present disclosure, the filling assembly 11 is displaced, substantially in a rigid manner, without performing any modifications or variations to the internal volume of the filling cone 14 and the passage duct 22. In other words, the filling assembly 11 is displaced as though it were single body between the operative positions. The filling cone 14 is configured to be displaced from the first position to the second position and vice versa, together with the passage duct 22 and the tubular duct 19, keeping an internal volume unvaried when passing from one position to the other.

Consequently, in order to load the casing 21 on the filling cone 14, the filling cone 14 may be displaced in practical manner, thereby facilitating the operations for an operator. At the same time, owing to the fact that the internal volume is kept unvaried, there is no leakage of food product from the filling cone 14. From a structural point of view, in order to allow this rigid displacement of the filling assembly, the passage duct 22 can be fixed to the twisting device 18 and to the tubular body 19, defined above, so as to allow the introduction of the food product into the tubular body 19 and then into filling cone 14. The passage duct 22 can be connected to the twisting device 10 and to the tubular body 19 so as to be able to translate integrally and rigidly with the twisting device 18 and the tubular body 19. At the same time, the tubular body 19 can be connected idle to the passage duct 22 so that a rotation about the longitudinal axis X of the tubular body 19 is not transmitted to the passage duct 22.

Consequently, the passage duct 22 can be translatable integrally with the filling cone 14 and with the entire twisting apparatus, in a linear and retractable manner, inside a cavity 25 of the support structure 24. This linear displacement or translation allows freeing of the end 17 of the filling cone 14 which is inserted inside the opening 13 of the braking device 12 and allows easy loading of the casing on said end 17 by an operator. In particular, in the embodiment shown the passage duct 22 is a tubular body and also the cavity 25 is substantially tubular.

According to an embodiment of the present disclosure, such as shown in the accompanying figures, the inlet conduit 31 can engage from below with respect to the support structure 24 so that product may be introduced from below into the passage duct 22.

In particular, the inlet conduit 31 is positioned below a base 28 and is in communication with the cavity 25 of the support structure 24. The inlet conduit 31 engages with the support structure 24 in the region of a perpendicular axis Y (loading axis). In this connection, it is pointed out that the bottom wall 32 of the support structure 24 has an opening 35 for placing the passage duct 22 in communication with the inlet conduit 31.

According to an embodiment of the present disclosure, such as shown in the accompanying figures, the inlet conduit 31 is an elbow-shaped conduit with an inlet mouth 33 having a substantially horizontal axis and an output mouth 34 having a substantially vertical axis. The passage duct 22 is also elbow-shaped with an input mouth 36 having a substantially vertical axis and an output mouth 37 having a substantially horizontal axis.

The inlet mouth 36 of the passage duct 22 and the output mouth 34 of the inlet conduit 31 can be located in axial alignment with each other and so as to communicate with each other, via the aforementioned opening 35, when the filling cone 14 is located in at least one operative position, for example, when the filling cone 14 is located in the first operative position.

Consequently, in an embodiment, such as in the figures, the inlet conduit 31 and the passage duct 22, when connected together, define a channel for the passage of the food product from the filling device to the processing apparatus 11, wherein the channel for passage of the food product from the filling machine is at least partially sinusoidal-shaped.

Owing to the introduction of the food product from below into the passage duct 22, it is possible to obtain a twisting apparatus 10 in which the inlet mouth 33 is situated below. This position of the inlet mouth 33 is fully compatible for connection with a filling machine.

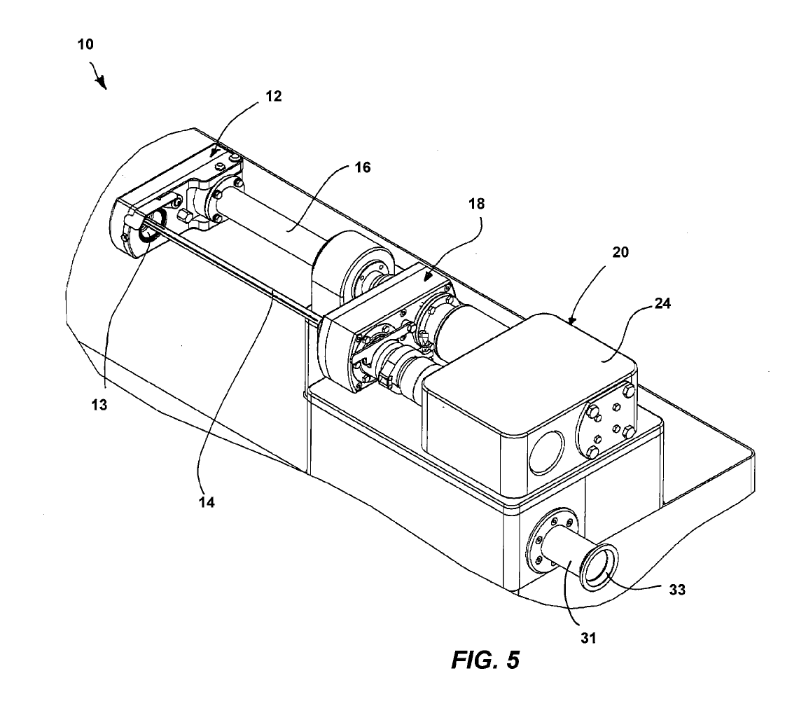

According to an embodiment of the present disclosure, such as shown in the accompanying figures, a third operative position is also envisaged, for example in FIG. 1 and FIG. 4, where the filling cone 14 is displaced laterally towards an operator, and the casing 21 may be mounted on the filling cone 14, substantially outside the volume or general shape of the twisting apparatus 10. In this third operative position, the filling cone 14 has a respective free end portion 17 in a spaced relationship from the opening 13 of the braking device 12. In this third operative position, the filling cone 14 is angularly displaced, or out of axial alignment, with respect to the opening 13 of the braking device 12, in a position which is retracted with respect to the first operative position and angularly displaced in a lateral direction, with respect to the path P. The angled position or third (laterally displaced) operative position may allow an operator to perform operations outside of the volume of the twisting apparatus 10, so as to avoid having to work in a restricted spaced between the components of the twisting apparatus 10.

Moreover no displacement of the braking device 12 can be required.

The filling cone 14 can be displaced together with the twisting apparatus 18, the passage duct 22 and the support structure 24 from the second position to the third position and vice versa, namely can be displaced from a position aligned with the braking device 12 into a position angularly displaced with respect to the braking device 12. The support structure 24 has a pivot portion 26 projecting downwards from a bottom wall 32 and arranged so as to be rotatable in a rotational seat 27 of a support base 28 of the frame 9. In other words, the support structure 24 is mounted rotatably about this axis Y. A rotation of the support structure 24 about the axis Y causes, as mentioned, an angular displacement of the filling cone 14, the twisting device 18 and the passage duct 22 from the second position to the third position. Such an angular displacement can be seen in FIG. 4. In the third operative position, the assembly formed by the filling cone 14, twisting device 18 and passage duct 22 allows the volume of the entire twisting apparatus 10 to be kept substantially constant and moreover does not require disassembly of any of the components of the twisting apparatus 10 with respect to the frame 9.

According to certain aspects of the present disclosure, the loading path P envisages at least one first portion, coinciding with the loading axis X of the filling cone 14, namely coinciding with the first operative position of the filling cone 14, and at least one second portion, different from the first portion, where the second portion forms an angle with the first portion and is coaxial with the axis of rotation Y. Consequently, the filling cone 14 is configured to rotate about an axis coinciding with at least one portion (e.g. second portion) of the loading path P.

The above configuration allows further compaction of the parts and limitation of the spaces and volumes of the twisting apparatus 10 as a whole. In fact, a rotation about the loading axis allows displacement of a limited number of parts or components for lateral displacement of the filling cone 14, by making use of the components or parts of the apparatus intended to form a loading path for the product. Moreover, as a result of this configuration, it is possible to obtain a twisting apparatus which is compact, despite being able to assume a plurality of operative positions. Consequently, it is possible to rotate the entire loading device 20, including the twisting device 18, about the axis Y, namely about the loading axis or axis of engagement of the inlet conduit 31 inside the cavity 25 of the support structure 24. As already mentioned above, the possibility of rotating the entire loading device 20 about the axis Y offers the advantage of being able to displace laterally the filling cone 14, for example, towards an operator, and also facilitating positioning of the casing on the filling cone 14, this manoeuvre being performed by means of a simple lateral rotation, with a reduced volume and reduced displacement of parts, while ensuring a high degree of compactness of the twisting apparatus 10.

It may also be noted that the inlet conduit 31 and the passage duct 22 have a respective vertical portion which is in axial alignment with the loading axis Y, namely the vertical rotational axis or pivot axis described above. As can be seen from FIGS. 7 and 8, the inlet conduit 31 and the passage duct 22 have a respective vertical portion, which is coaxial with the pivot portion 26 of the support structure 24. Consequently, the support structure 24 is rotated from the second operative position to the third operative position, rotating about the same loading axis Y along which the product is introduced from below.

A mode of operation of the twisting apparatus 10 may be substantially as described below.

Initially, in order to load a casing on the free end 17 of the filling cone 14 (in this condition the filling machine is set to the pause condition), the filling cone 14 and the passage duct 22 are displaced linearly inside the support structure 24. Owing to the layout of the parts described above, the inlet mouth 36 of the passage duct 22 is not aligned with the loading axis X, and the side wall 23 of the passage duct 22 closes the opening 35, without causing variations in the internal volume of the entire path of the food product.

Thereafter, the entire loading device 20 is angularly rotated about the loading axis X so as to move the filling cone 14 into the vicinity of the operator who is situated on one side of the twisting system 10. The free end 17 can be accessed by the operator in order to perform the operations for insertion of the casing 21. At the same time, the operator may operate the filling cone 14 without placing his/her hands directly inside the twisting apparatus 10. After loading the casing 21, the entire loading device 20 is positioned again in its original position (first operative position) with the filling cone 14 aligned and inserted inside the respective opening 13 of the braking device 12. In this condition, the braking device 12 stably retains the casing 21 on the filling cone 14 so as to ensure the necessary tension for optimum filling of the casing 21.

Then, the filling machine can be started and the food product can be introduced via the inlet conduit 31 so as to be introduced through the filling cone 14 into the casing 21. At periodic intervals or continuously, the twisting device 18 is activated and causes rotation of the filling cone 14 so as to perform momentary twisting of the casing 21 once the required amount of product has been filled inside the casing 21.

The examples set forth above are provided to give those of ordinary skill in the art a complete disclosure and description of how to make and use the embodiments of the disclosure, and are not intended to limit the scope of what the inventors regard as their disclosure. Modifications of the above-described modes for carrying out the disclosure may be used by persons of skill in the art, and are intended to be within the scope of the following claims. All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

1. A twisting apparatus comprising:
a loading device adapted to load a food product in a casing, and
a braking device, wherein
the loading device comprises:
a filling assembly and an inlet conduit for feeding the food product into the filling assembly, and
a feed path of the food product,
wherein:
the feeding path is defined in the filling assembly,
said filling assembly is intended to support the casing,
the filling assembly includes a passage duct,
the inlet conduit is structurally separate from said passage duct,
the filling assembly is configured to assume at least a first operative position in which the filling assembly is connected to the braking device and said inlet conduit is in fluid communication with said passage duct, and a second operative position in which the filling assembly is linearly displaced in a spaced relationship or detached from the braking device, and
the passage duct closes or interrupts the fluid communication with the inlet conduit, and/or serves as a shutter for said feed path of the food product in said second operative position.

2. The twisting apparatus according to claim 1, wherein the passage duct further comprises a side wall,
wherein said inlet conduit is placed on one side of the passage duct facing said side wall and wherein, in said first operative position, said inlet conduit is in fluid communication with an opening of the side wall and
wherein, in said second operative position, the side wall closes or interrupts the fluid communication with the inlet conduit.

3. The twisting apparatus according to claim 1, wherein, the inlet mouth of the passage duct is aligned axially with an output mouth of the inlet conduit when the filling assembly is in the first operative position.

4. The twisting apparatus according to claim 3, wherein said filling assembly is mounted rotatably about an axis of rotation and said filling assembly is configured to be rotated about said axis of rotation when said filling assembly is in said second operative position.

5. The twisting apparatus according to claim 1, wherein the inlet conduit is elbow-shaped and comprising an inlet mouth with a horizontal axis and an output mouth with a vertical axis, said output mouth being configured to be placed in communication with the passage duct.

6. The twisting apparatus according to claim 1, wherein the inlet conduit is placed below the passage duct.

7. The twisting apparatus according to claim 1, wherein the loading device comprises a support structure for supporting the filling assembly,
wherein the support structure includes a casing body defining an internal cavity, and
wherein, in said second operative position, the passage duct is at least partially housed in an internal cavity, said support structure being stationary both in said first operative position and in said second operative position.

8. The twisting apparatus according to claim 7, wherein the inlet conduit is in communication with the internal cavity of the support structure and engages with the support structure in the region of a respective opening of the support structure.

9. The twisting apparatus according to claim 8, wherein the side wall of said passage duct closes the opening of the support structure in said second position.

10. The twisting apparatus according to claim 7, wherein the support structure includes a pivot portion, said pivot portion being arranged rotatable in a rotational seat of a support base and being coaxial with an output mouth of said inlet conduit.

11. The twisting apparatus according to claim 3, wherein said rotational seat is coaxial with said inlet mouth and said output mouth of the inlet conduit when the filling assembly is in the first operative position.

12. The twisting apparatus according to claim 1, wherein the filling assembly comprising:
a filling cone adapted to support the casing, and
a twisting device arranged between the filling cone and the passage duct,
wherein the twisting device being able to rotate the filling cone,
wherein the filling cone being connected idle to the passage duct such that the filling cone translates together with the passage duct, and
wherein a rotation about an axis of the filling cone is not transmitted to the passage duct.
